(19) United States
(12) Patent Application Publication
(10) Pub. No.: US 2007/0274028 A1
(43) Pub. Date: Nov. 29, 2007

(54) METHOD FOR REPAIRING ELECRICAL CIRCUIT OF CIRCUIT BOARD

(75) Inventors: Shih-Ping HSU, Hsin-chu (TW); Chao-Wen SHIH, Hsin-chu (TW)

Correspondence Address: SAWYER LAW GROUP LLP, P O BOX 51418, PALO ALTO, CA, 94303, US

(73) Assignee: PHOENIX PRECISION TECHNOLOGY CORPORATION, Hsin-chu (TW)

(21) Appl. No.: 11/752,230

(22) Filed: May 22, 2007

(30) Foreign Application Priority Data
May 24, 2006 (TW) 095118403

(51) Int. Cl. H02B 1/00

(52) U.S. Cl. 361/600

(57) ABSTRACT

A method for repairing an electrical circuit of a circuit board is proposed. The method includes providing a circuit board having a patterned circuit layer, wherein the patterned circuit layer includes an electrical circuit having at least one defect formed therein; and providing a microelectrode for performing a micro-electroplating process at a position corresponding to the defect of the electrical circuit to form a circuit material, so as to repair the electrical circuit of the circuit board. Alternatively, the micro-electroplating process may be replaced with a micro-deposition process by using a micro-droplet to form the circuit material at the aforementioned position.

### CROSS-REFERENCE TO RELATED APPLICATIONS

Under 35 U.S.C. 119(e), this application claims the benefit of priority to Taiwanese Patent Application No. 095118403, filed May 24, 2006, all of which is incorporated herein by reference.

### FIELD OF THE INVENTION

The present invention relates to a method for repairing an electrical circuit of a circuit board and, more particularly, to a method for repairing an electrical circuit of a circuit board having a defect formed therein.

### DESCRIPTION OF RELATED ART

Along with the blooming development of electronic industry, it has endeavored to increasingly provide electronic products with multiple functions and high performances. In order to satisfy the requirements of high integration and miniaturization for semiconductor packages, circuit boards formed with fine circuits and small pitches are accordingly required, so as to allow more electrical circuits to be accommodated on the same unit area of a circuit board. Current circuit board has dimensions including line width, trace pitch and aspect ratio reduced from greater than 100 μm to about 30 μm, and further dimensional decrease is endeavored.

However, as electrical circuits and density of electronic components on the circuit board are increased to meet the requirement of integration, a defect such as an open circuit, a circuit corner damage owing to improper etching, or a circuit deformity occurred in an electrical circuit is dramatically increased during fabrication processes of the circuit board, which can effectively reduce electrical performances and quality of the circuit board.

Since an electrical circuit in which the defect occurred would reduce electrical performances and quality of the circuit board, it would be generally discarded. Accordingly, a new electrical circuit, which having the same electrical performances as the aforementioned electrical circuit, would be formed either on the area neighboring the aforementioned electrical circuit or on any another area of the circuit board.

However, the conventional technologies have significant drawbacks, not only the usable areas of the circuit board are restricted, but also time and processes of the overall fabrication are increased. Furthermore, the exact circuit board in which the defects occurred would be discarded as the inferior products and another new one is to be replaced, which can waste time and costs of the fabrication processes.

As a result, it is desirable to provide a method for repairing electrical circuit that avoids the shortcomings of the prior art.

### SUMMARY OF THE INVENTION

It is therefore an object of the invention to provide a method for repairing an electrical circuit of a circuit board, which can recover electrical performances of the circuit board.

It is another object of the invention to provide a method for repairing an electrical circuit of a circuit board, which can recover quality of circuit board.

Furthermore, it is another object of the invention to provide a method for repairing an electrical circuit of a circuit board, which can reduce the costs of production.

Yet, it is another object of the invention to provide a method for repairing an electrical circuit of a circuit board, which can simplify the overall fabrication processes.

In accordance with the above and other objectives, the present invention proposes a method for repairing an electrical circuit of a circuit board, comprising the steps of: providing a circuit board having a patterned circuit layer, wherein the patterned circuit layer includes an electrical circuit having at least one defect formed therein; and providing a microelectrode for performing a micro-electroplating process at a position corresponding to the defect of the electrical circuit, so as to repair the electrical circuit of the circuit board.

Forming the patterned circuit layer comprises the steps of: forming a conductive layer on at least one surface of the circuit board; and forming a resist layer on the conductive layer, wherein the resist layer has a plurality of openings formed therein to expose the conductive layer, so as to electroplate by the conductive layer and form the patterned circuit layer.

During the micro-electroplating process, the microelectrode functions as an oxidizing terminal of electroplating and the electrical circuit of the circuit board contacting another microelectrode functions as a reducing terminal of electroplating, thereby a current path is generated for performing a micro-electroplating process. Thus, the microelectrode is used to plate a circuit material at the position corresponding to the defect of the electrical circuit to form an electrical circuit segment, so as to repair the electrical circuit of the circuit board. The circuit material is selected from the group consisting of Lead, Tin, Silver, Copper, Gold, Bismuth, Antimony, Zinc, Nickel, Zirconium, Magnesium, Indium, Tellurium, Gallium, and any alloy thereof. Furthermore, the foregoing step can also be performed after removing the resist layer and the conductive layer covered by the resist layer.

Besides, the defect in the electrical circuit is a deficient portion selected from the group consisting of an open circuit, a corner damage, and a circuit deformity.

In another embodiment, the present invention proposes another method for repairing an electrical circuit of a circuit board, comprising the steps of: providing a circuit board having a patterned circuit layer, wherein the patterned circuit layer includes an electrical circuit having at least one defect formed therein; and supplying a micro-droplet for performing a micro-deposition process at a position corresponding to the defect of the electrical circuit, so as to repair the electrical circuit of the circuit board.

Referring to the foregoing embodiment, the micro-droplet is supplied for performing the micro-deposition process, so as to deposit a circuit material at a position corresponding to the defect of the electrical circuit. Furthermore, the foregoing step can also be performed after a step of removing the resist layer and the conductive layer covered by the resist layer.

Yet in another embodiment, the present invention proposes another method for repairing an electrical circuit of a circuit board, comprising the steps of: providing a circuit board having a patterned circuit layer, wherein the patterned circuit layer includes an electrical circuit having at least one defect formed therein; supplying a micro-droplet for performing a micro-deposition process to form a conductive layer at a position corresponding to the defect of the electrical circuit; and providing a microelectrode for performing a micro-electroplating process on the conductive layer, so as to repair the electrical circuit of the circuit board.

Therefore, in the present invention, the defect in the electrical circuit is repaired by a micro-electroplating process or a micro-deposition process, and to form a circuit material at a position corresponding to the defect of the electrical circuit by using of microelectrode or micro-droplet, thereby ensuring the integrity of circuit structure and recovering the electrical performances. Besides, the present invention avoids the conventional problems of reducing electrical performances by the incomplete structure of the electrical circuit, which can reduce the function of the circuit board, so that production yield and product reliability are effectively improved, and costs of the fabrication are reduced.

### BRIEF DESCRIPTION OF DRAWINGS

The present invention can be more fully understood by reading the following detailed description of the preferred embodiments, with reference made to the accompanying drawings, wherein:

FIGS. 1A-1B are illustrative a cross-sectional view and a top view of a structure of a circuit board according to the present invention.

FIG. 2 is illustrative a cross-sectional view representing a method for repairing an electrical circuit of a circuit board according to a first preferred embodiment of the present invention;

FIG. 3 is illustrative a cross-sectional view representing a method for repairing an electrical circuit of a circuit board according to a second preferred embodiment of the present invention;

FIGS. 4A to 4B are illustrative cross-sectional views representing a method for repairing an electrical circuit of a circuit board according to a third preferred embodiment of the present invention; and

FIGS. 5A to 5B are illustrative cross-sectional views representing a method for repairing an electrical circuit of a circuit board according to a fourth preferred embodiment of the present invention.

### DETAILED DESCRIPTION OF PREFERRED EMBODIMENTS

Wherever possible in the following description, like reference numerals will refer to like elements and parts unless otherwise illustrated.

### First Preferred Embodiment

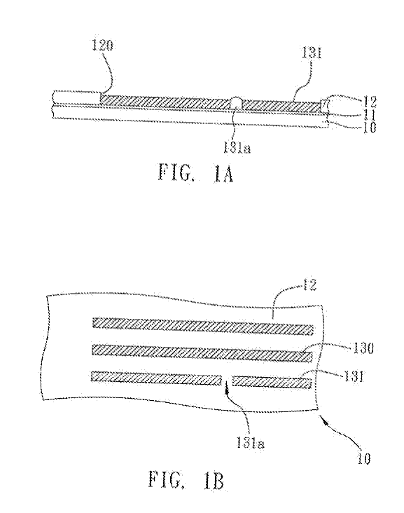

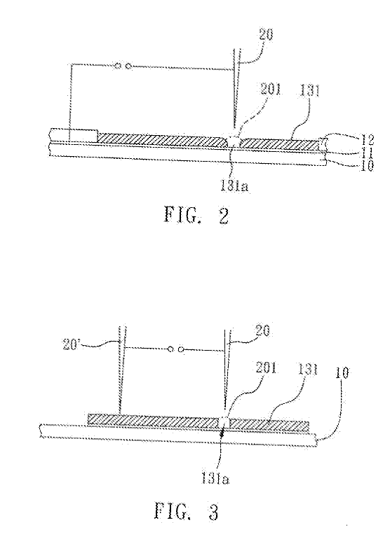

FIGS. 1A to 1B are a cross-sectional view and a top view of a structure of a circuit board according to the present invention, and FIG. 2 is illustrative a cross-sectional view representing a method for repairing a circuit defect of a circuit board according to a first preferred embodiment of the present invention.

Referring to FIG. 1A, first of all, a circuit board 10 is provided, a conductive layer 11 is formed on at least one surface of the circuit board 10, and a resist layer 12 is formed on the conductive layer 11, wherein the resist layer 12 has a plurality of openings 120 formed therein to expose a portion of the conductive layer 11, so as to form a patterned circuit layer having a plurality of electrical circuits 130 and 131 on the exposed area of the conductive layer 11 by an electroplating process, and there is a defect in the electrical circuit 131, wherein a portion of the electrical circuit 131 is deficient. In this embodiment, the defect in the electrical circuit 131 is an open circuit defect 131a, but it should be understood that the type of the defect is not limited to that shown in this embodiment, and any other type of defect such as a corner damage, and a circuit deformity is also applicable in the present invention.

Referring to FIG. 2, a microelectrode 20 is supplied for performing a micro-electroplating process on the area of the electrical circuit 131 where the open circuit defect 131a occurred, thereby, an electrical circuit segment 201 is formed, so as to repair the electrical circuit 131 in which the open circuit defect 131a occurred. By the above process, the microelectrode 20 functions as an oxidizing terminal of electroplating and the conductive layer 11 of the circuit board 10 functions as a reducing terminal of electroplating, as a result, a current path is generated for performing a micro-electroplating process, and the microelectrode 20 is used to plate the circuit material at the position corresponding to the defect of the electrical circuit, thereby an electrical circuit segment 201 is formed so as to eliminate the open circuit defect 131a, and to recover the electrical performances of the electrical circuit 131. In the above embodiment, the circuit material can be made of Lead, Tin, Silver, Copper, Gold, Bismuth, Antimony, Zinc, Nickel, Zirconium, Magnesium, Indium, Tellurium, Gallium, and any alloy thereof.

### Second Preferred Embodiment

FIG. 3 is illustrative a cross-sectional view representing a method for repairing a circuit defect of a circuit board according to a second preferred embodiment of the present invention. In this embodiment, different from the first embodiment, the micro-electroplating process is performed after a step of removing the resist layer and the conductive layer covered by the resist layer, that is to say, the electrical circuit layer of the circuit board is entirely exposed by removing the resist layer and the conductive layer, and the microelectrode 20 functions as an oxidizing terminal of electroplating, the electrical circuit 131 of the circuit board 10 contacting another microelectrode 20′ functions as a reducing terminal of electroplating, so as to generate a current path for performing a micro-electroplating process, and the microelectrode 20 is used to plate the circuit material on the area where the open circuit defect 131a occurred in the electrical circuit 131, thereby an electrical circuit segment 201 is formed.

### Third Preferred Embodiment

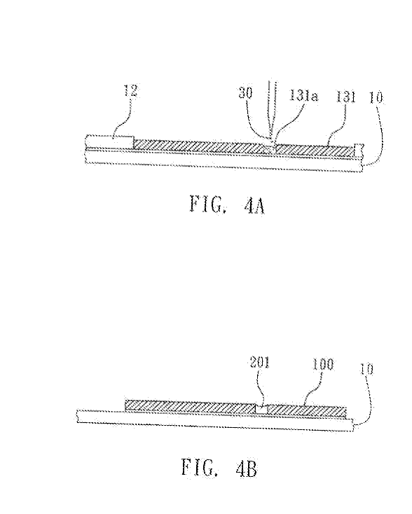

FIGS. 4A to 4B are illustrative cross-sectional views representing a method for repairing a circuit defect of a circuit board according to a third preferred embodiment of the present invention. In this embodiment, different from the first embodiment, micro-droplet is used to repair the electrical circuit in which the defect occurred, and the steps for the repairing process will be described in detail as follows.

Referring to FIG. 4A, a conductive layer is formed on at least one surface of the circuit board 10, and a resist layer is formed on the conductive layer 11, wherein the resist layer has a plurality of opening formed therein to expose the conductive layer, so as to form a patterned circuit layer on the exposed area of the conductive layer by an electroplating process, and the electrical layer having an electrical circuit 131 in which an open circuit defect 131a occurred. The micro-droplet 30 is supplied for performing an micro-deposition process, so as to deposit the circuit material at the position corresponding to the defect of the electrical circuit, thereby an electrical circuit segment 201 is formed to repair the open circuit defect 131a occurred in the electrical circuit 131. Thereafter, as shown in FIG. 4B, a step of removing the resist layer and the conductive layer covered by the resist layer is performed. In this embodiment, the micro-droplet may be a liquid solution mixed with metal ion, reducing agent, catalyst, complex agent, stabilizer, buffer, wetting agent, brightener, and so on.

Besides, the above process further comprises a step of removing the resister layer and the conductive layer covered by the resist layer, subsequently, the micro-droplet 30 is supplied to form the electrical circuit segment 201 on the area where the open circuit defect 131a occurred in the electrical circuit 131, and to repair the electrical circuit 131.

### Fourth Preferred Embodiment

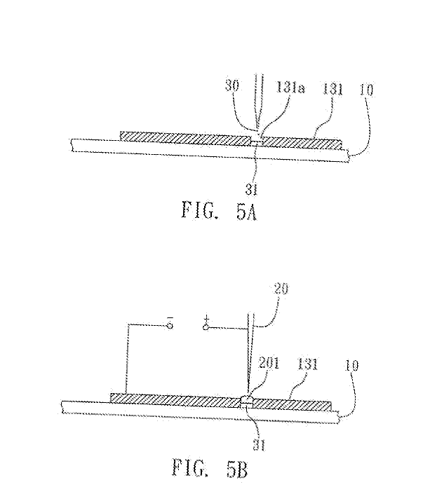

FIGS. 5A to 5B are illustrative a fourth preferred embodiment of the present invention which is combined with the first and second preferred embodiment. Referring to FIG. 5A, firstly, the micro-droplet 30 is deposited by a micro-electroplating process, so as to form a conductive layer 31 on the area where the open circuit defect 131a is occurred in the electrical circuit 131 of the circuit board 10 fabricated by employing the aforementioned process. Referring to FIG. 5B, then using the conductive layer 31 as a cathode and a microelectrode 20 as an anode, so as to form the electrical circuit segment 201 on the area where the open circuit defect 131a occurred in the electrical circuit 131, and to repair the electrical circuit 131.

Furthermore, in the above first, second and third preferred embodiment, the electrical circuit segment 201 is made of the same material as the electrical circuit 131. Alternatively, the electrical circuit segment 201 can be made of a different material from the electrical circuit 131. The electrical circuit segment 201 can be made of either a single circuit material or a plurality of circuit materials that stacked one another.

According to the present invention, the electrical circuit in which the defect occurred can be repaired by a micro-electroplating process or a micro-deposition process, and to form an electrical circuit segment at the position corresponding to the defect of the electrical circuit by using of microelectrode or micro-droplet. Thus, the present invention ensures the integrity of circuit structure and the electrical performances, so as to improve the production yield of the circuit board.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for repairing an electrical circuit of a circuit board, comprising:
providing a circuit board having a patterned circuit layer, wherein the patterned circuit layer includes an electrical circuit having at least one defect formed therein; and
providing a microelectrode for performing a micro-electroplating process at a position corresponding to the defect of the electrical circuit, so as to repair the electrical circuit of the circuit board.

2. The method for repairing an electrical circuit of a circuit board of claim 1, wherein the microelectrode functions as an oxidizing terminal of electroplating and the electrical circuit of the circuit board contacting another microelectrode functions as a reducing terminal of electroplating, so as to form a circuit material by performing a micro-electroplating process at the position corresponding to the defect of the electrical circuit.

3. The method for repairing an electrical circuit of a circuit board of claim 1, wherein the patterned circuit layer is formed by the steps of:
forming a conductive layer on at least one surface of the circuit board; and
forming a resist layer on the conductive layer, wherein the resist layer has a plurality of openings formed therein to expose the conductive layer, such that on electroplating process can be performed via the conductive layer to form the patterned circuit layer.

4. The method for repairing an electrical circuit of a circuit board of claim 3, wherein the microelectrode functions as an oxidizing terminal of electroplating and the conductive layer functions as a reducing terminal of electroplating, so as to form a circuit material by performing the micro-electroplating process at the position corresponding to the defect of the electrical circuit.

5. The method for repairing an electrical circuit of a circuit board of claim 4, further comprising removing the resist layer and the conductive layer covered by the resist layer.

6. The method for repairing an electrical circuit of a circuit board of claim 4, wherein the circuit material is selected from the group consisting of Lead, Tin, Silver, Copper, Gold, Bismuth, Antimony, Zinc, Nickel, Zirconium, Magnesium, Indium, Tellurium, Gallium, and any alloy thereof.

7. The method for repairing an electrical circuit of a circuit board of claim 4, wherein the circuit material is formed at the position corresponding to the defect of the electrical circuit by forming a single circuit material or stacking a plurality of circuit materials.

8. The method for repairing an electrical circuit of a circuit board of claim 1, wherein the defect of the electrical circuit is defined as a deficient portion selected from the group consisting of an open circuit, a corner damage, and a circuit deformity.

9. A method for repairing an electrical circuit of a circuit board, comprising:
providing a circuit board having a patterned circuit layer, wherein the patterned circuit layer includes an electrical circuit having at least one defect formed therein; and
supplying a micro-droplet for performing a micro-deposition process at a position corresponding to the defect of the electrical circuit, so as to repair the electrical circuit of the circuit board.

10. The method for repairing an electrical circuit of a circuit board of claim 9, wherein the patterned circuit layer is formed by the steps of:
forming a conductive layer on at least one surface of the circuit board; and
forming a resist layer on the conductive layer, wherein the resist layer has a plurality of openings formed therein to expose the conductive layer, such that on electroplating process can be performed via the conductive layer to form the patterned circuit layer.

11. The method for repairing an electrical circuit of a circuit board of claim 10, further comprising removing the resist layer and the conductive layer covered by the resist layer.

12. The method for repairing an electrical circuit of a circuit board of claim 9, wherein the defect of the electrical circuit is defined as a deficient portion selected from the group consisting of an open circuit, a corner damage, and a circuit deformity.

13. The method for repairing an electrical circuit of a circuit board of claim 9, wherein the micro-deposition process is performed to repair the electrical circuit by supplying the micro-droplet and depositing a circuit material at the position corresponding to the defect of the electrical circuit.

14. The method for repairing an electrical circuit of a circuit board of claim 13, wherein the circuit material is selected from the group consisting of Lead, Tin, Silver, Copper, Gold, Bismuth, Antimony, Zinc, Nickel, Zirconium, Magnesium, Indium, Tellurium and Gallium, and any alloy thereof.

15. The method for repairing an electrical circuit of a circuit board of claim 13, wherein the circuit material is formed at the position corresponding to the defect of the electrical circuit by forming a single circuit material or stacking a plurality of circuit materials.

16. A method for repairing an electrical circuit of a circuit board, comprising:
providing a circuit board having a patterned circuit layer, wherein the patterned circuit layer includes an electrical circuit having at least one defect formed therein;
supplying a micro-droplet for performing a micro-deposition process to form a conductive layer at a position corresponding to the defect of the electrical circuit; and
providing a microelectrode for performing a micro-electroplating process on the conductive layer, so as to repair the electrical circuit of the circuit board.

17. The method for repairing an electrical circuit of a circuit board of claim 16, wherein the defect of the electrical circuit is defined as a deficient portion selected from the group consisting of an open circuit, a corner damage, and a circuit deformity.

18. The method for repairing an electrical circuit of a circuit board of claim 16, wherein the conductive layer is made of a material selected from the group consisting of Lead, Tin, Silver, Copper, Gold, Bismuth, Antimony, Zinc, Nickel, Zirconium, Magnesium, Indium, Tellurium and Gallium, and any alloy thereof.

19. The method for repairing an electrical circuit of a circuit board of claim 16, wherein the microelectrode functions as an oxidizing terminal of electroplating and the electrical circuit of the circuit board contacting another microelectrode functions as a reducing terminal of electroplating, so as to form a circuit material by performing a micro-electroplating process at the position corresponding to the defect of the electrical circuit.

20. The method for repairing an electrical circuit of a circuit board of claim 19, wherein the circuit material is selected from the group consisting of Lead, Tin, Silver, Copper, Gold, Bismuth, Antimony, Zinc, Nickel, Zirconium, Magnesium, Indium, Tellurium and Gallium, and any alloy thereof.

21. The method for repairing an electrical circuit of a circuit board of claim 19, wherein the circuit material is formed at the position corresponding to the defect of the electrical circuit by forming a single circuit material or stacking a plurality of circuit materials.
